(19) United States
(12) Patent Application Publication
(10) Pub. No.: US 2007/0124149 A1
(43) Pub. Date: May 31, 2007

(54) User-defined speech-controlled shortcut module and method thereof

(76) Inventors: Jia-Lin Shen, Taoyuan Hsien (TW); Tien-Ming Hsu, Taoyuan Hsien (TW)

Correspondence Address: MICHAEL W. TAYLOR, P.O. BOX 3791, ORLANDO, FL, 32802-3791, US

(21) Appl. No.: 11/521,023

(22) Filed: Sep. 14, 2006

(30) Foreign Application Priority Data
Nov. 30, 2005 (TW) 094142205

(51) Int. Cl. G10L 21/00

(52) U.S. Cl. 704/275

(57) ABSTRACT

A speech-controlled shortcut module for an electronic device to edit and execute at least a speech-controlled function item therein is provided. The provided module contains a speech-controlled database storing the at least a speech-controlled function item having a command name being a name of the at least a speech-controlled function item, and a function shortcut storing an execution path of the at least a speech-controlled function item and formed by the electronic device to record at least an option of an hierarchical function menu sequentially selected by a user, wherein when the user inputs a voice command, the electronic device recognizes the voice command and executes a corresponding speech-controlled function item.

### FIELD OF THE INVENTION

The present invention relates to a user-defined speech-controlled shortcut module and the method thereof, in particular to a user-defined speech-controlled function shortcut module and the method thereof applicable to an electronic device having a speech-controlled man-machine interface (MMI).

### BACKGROUND OF THE INVENTION

The speech is a fast and convenient MMI indeed. However, as a result of the user's habit and operational correctness, it is not quite successful to replace the current MMI with the speech. One of the reasons is that the attempt to provide all the commands with the speech-controlled function is not practical. Even in the current computer system, the way to do that is to give certain functions “shortcuts”. For instance, the user is allowed to set up the “shortcut” on the screen of a computer so as to show the frequently used program or document on the desktop with a simple icon. Consequently, it is unnecessary for the user to do the search throughout multiple folders. Another instance is that there are a few hot keys disposed on an electronic device, enabling the user to skip a hierarchical menu selection and execute the frequently used commands in a snap.

The current speech-controlled functions are all defined by the system. However, this results in numerous undesired speech-controlled commands for the user. Besides, this also increases the system load (e.g. more time is required for recognition), and the recognition rate also gets worse. From the user's viewpoint, the speech-controlled functions are primarily attempted to provide the user with a more convenient and faster MMI. Therefore, it will be more convenient for the user if he can define what functions shall be given the speech-controlled commands on his own. As the desktop computer and the notebook computer both have a big screen, the user can define the shortcut on the screen conveniently. For some devices, such as a portable device and a regular electronic product, what we can see is that the system generates certain hot keys for the frequently used functions and leaves the rest functions to be searched throughout a hierarchical menu structure via an on-screen display interface. Inevitably, the number of these hot keys tends to be less while the speech becomes a good tool in place of these hot keys. Therefore, the user can add certain function items according to actual needs, and the function items that are not frequently used or often incur recognition errors can be deleted. Meanwhile, there is no limitation in the physical key number. As a consequence, using the user-defined speech-controlled function shortcut can address a fast and efficient MMI.

Based on the above, in order to overcome the drawbacks in the prior art, the present invention provides an improved module and method for the user-defined speech-controlled shortcut.

### SUMMARY OF THE INVENTION

In accordance with a first aspect of the present invention, a speech-controlled shortcut module for an electronic device to edit and execute at least a speech-controlled function item therein is provided. The provided module contains a speech-controlled database storing the at least a speech-controlled function item having a command name being a name of the at least a speech-controlled function item, and a function shortcut storing an execution path of the at least a speech-controlled function item and formed by the electronic device to record at least an option of an hierarchical function menu sequentially selected by a user, wherein when the user inputs a voice command, the electronic device recognizes the voice command and executes a corresponding speech-controlled function item.

Preferably, the at least a speech-controlled function item further comprises a status indicator being one of an operating state and an idle state.

Preferably, the electronic device comprises a microphone for the user to input the voice command.

Preferably, the module further comprising a speech-controlled function editing unit provides the user at least one selected from a group consisting of a speech-controlled function item adding function, a speech-controlled function item disabling function, a speech-controlled function item modifying function and a speech-controlled function item macro function.

Preferably, the speech-controlled function item adding function enables the electronic device to record a new speech-controlled function item resulting from the at least an option of the hierarchical function menu sequentially selected by the user under a speech-controlled function editing mode, to add the new speech-controlled function item to the speech-controlled function database, and to set the status indicator of the new speech-controlled function item to be the operating state, and the speech-controlled function item disabling function sets the status indicator of the speech-controlled function item to be the idle state.

Preferably, the speech-controlled function item modifying function enables to modify the command name of the at least a speech-controlled function item.

Preferably, the speech-controlled function item macro function enables to group a plurality of speech-controlled function items as a macro so as to be added to the speech-controlled function database as a new speech-controlled function item, a command name of the new speech-controlled function item is defined by the user, the plurality of speech-controlled items selected are sequentially executed in accordance with a function shortcut of the new speech-controlled function item, and a status indicator of the new speech-controlled function item is set to be the operating state.

Preferably, the speech-controlled shortcut module further includes a speech-controlled function executing unit, wherein an electronic data converted from a voice command is recognized while the user inputs the voice command and the speech-controlled function executing unit is activated, the electronic data is sequentially compared with the command name of the at least a speech-controlled function item having the status indicator being the operating state so as to identify a matching speech-controlled function, the matching speech-controlled function is executed in accordance with the function shortcut thereof, and the electronic data is deleted after compared with the voice command.

In accordance with a second aspect of the present invention, a speech-controlled shortcut editing method for an electronic device to edit a speech-controlled function database is provided. The module contains plural speech-controlled function items and an operating speech-controlled function item, wherein each of the speech-controlled function items comprises a plurality of fields having at least a command name, a function shortcut and a status indicator, under a speech-controlled function editing mode, comprising steps of: (1) adding a new speech-controlled function item to the speech-controlled function database; (2) disabling the operating speech-controlled function item; (3) modifying at least a specific one of the plurality of fields; and (4) adding a macro to execute a plurality of selected speech-controlled function items in accordance with a function shortcut to the speech-controlled function database.

Preferably, the step (1) comprises steps of: recording at least an option selected from a hierarchical function menu to generate the new speech-controlled function item; inputting a command name of the new speech-controlled function item; and adding the new speech-controlled function item to the speech-controlled function database.

Preferably, the status indicator of the new speech-controlled function item is set to be an operating state in the step (1).

Preferably, the step (2) sets the status indicator of the operating speech-controlled function item from the operating state to an idle state.

Preferably, the specific one field in the step (3) is the command name.

Preferably, the step (4) at least comprises steps of: forming a new speech-controlled function item by selecting the plurality of speech-controlled function items of the macro; inputting a command name of the new speech-controlled function item; generating a corresponding function shortcut of the new speech-controlled function item to execute the plurality of selected speech-controlled function items; and adding the new speech-controlled function item to the speech-controlled function database.

In accordance with a third aspect of the present invention, a speech-controlled shortcut executing method for an electronic device to execute a speech-controlled function item in a speech-controlled function database is provided. The provided method contains a plurality of speech-controlled function items, wherein each of the plurality of speech-controlled function items comprises a command name, a first function shortcut and a status indicator under a speech-controlled function editing mode, comprising steps of: (1) inputting a voice command; (2) recognizing the voice command and then converting it into an electronic datum; (3) searching a next speech-controlled function item in the speech-controlled function database having the status indicator being an operating state as a current speech-controlled function item; (4) comparing the electronic datum with the command name of the current speech-controlled function items; (5) executing a the speech-controlled function item in accordance with the function shortcut of the current speech-controlled function item having the command name matching the electronic datum; and (6) resuming the step (3) when the electronic datum doesn't match the command name of the current speech-controlled function item and the current speech-controlled function item is non-final in the speech-controlled function database.

The foregoing and other features and advantages of the present invention will be more clearly understood through the following descriptions with reference to the drawing, wherein:

### BRIEF DESCRIPTION OF THE DRAWINGS

FIG. 1 is a schematic diagram showing the electronic device having a speech-controlled function according to a preferred embodiment of the present invention;

FIG. 2 is a schematic diagram showing the hierarchical menu selection having a speech-controlled function according to a preferred embodiment of the present invention;

FIG. 3 is a flow chart of the user-defined speech-controlled function shortcut editing method according to a preferred embodiment of the present invention; and

FIG. 4 is a flow chart of the user-defined speech-controlled function executing method according to a preferred embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purposes of illustration and description only; it is not intended to be exhaustive or to be limited to the precise form disclosed.

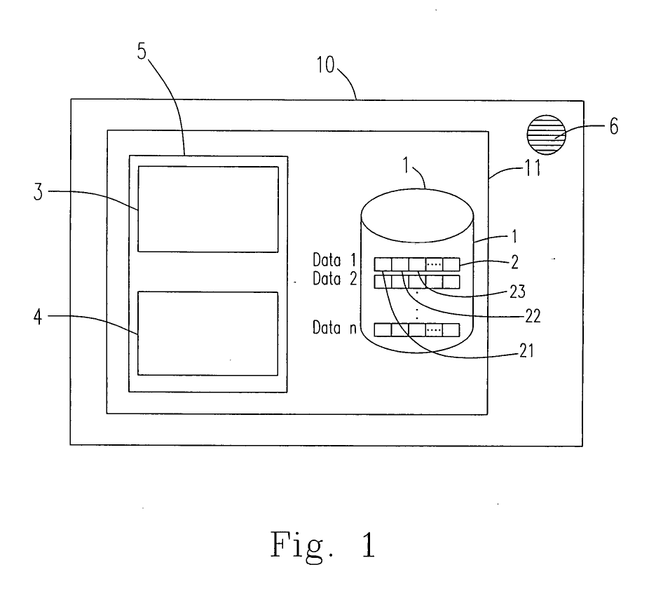

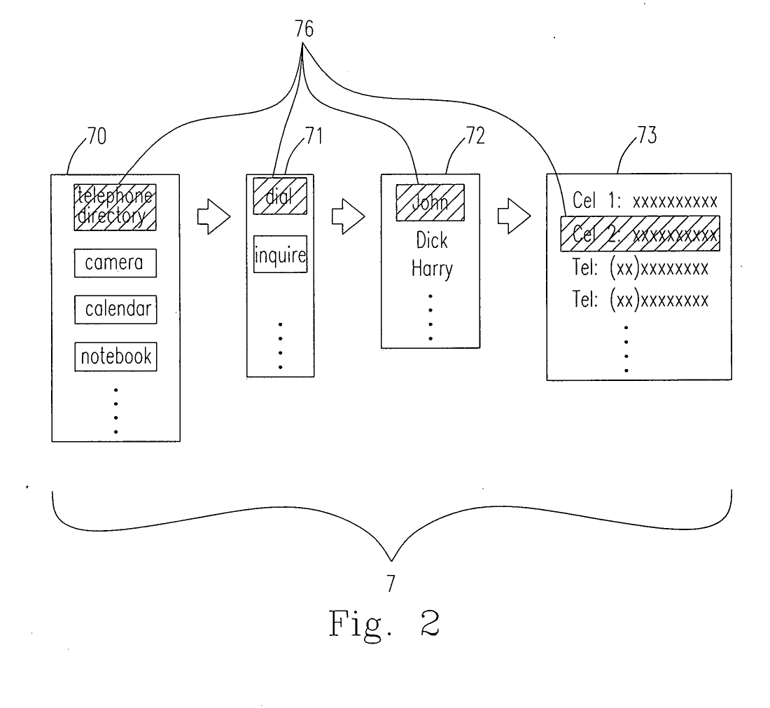

Please refer to FIG. 1, which is a schematic diagram showing the electronic device having a speech-controlled function according to a preferred embodiment of the present invention. The electronic device 10 includes a user-defined speech-controlled shortcut module 11 and a microphone 6. The module 11 at least contains a speech-controlled function database 1, a speech-controlled function editing unit 3 and a speech-controlled function executing unit 4. The database 1 is used to store all the speech-controlled function items 2 selected by the user, which are usually stored in a storage device (not shown). Each of the speech-controlled function items 2 in the database 1 corresponds to a record in the database 1 and contains at least three fields—a command name 21, a function shortcut 22 and a status indicator 23. The command name 21 is a name of a speech-controlled function name defined by the user. The speech-controlled function shortcut 22 is an execution path of the speech-controlled function item 2, which is formed by recording at least an option sequentially selected from a hierarchical menu 7 (please refer to FIG. 2) by the user in a speech-controlled function editing mode via the electronic device 10. The status indicator 23 is either an operating state or an idle state of the user-defined speech-controlled function item 2. When the user inputs a speech command into the electronic device 10 via a microphone 6, the electronic device 10 converts the speech command into an electronic datum. The electronic datum is compared with the command name 21 of the speech-controlled function item 2 having the status indicator 23 being the operating state, so as to find out a matching speech-controlled function item 2 and execute it in accordance with the function shortcut 22 thereof.

The speech-controlled editing unit 3 and the speech-controlled executing unit 4 are the modules in the speech-controlled function driver 5 of the electronic device 10 responsible for editing and executing the speech-controlled functions. In general, the functions of such modules mainly provide an MMI, a database and a back end processing. Specifically, the speech-controlled function edit module 3 provides the user a speech-controlled function item adding function, a speech-controlled function item disabling function, a speech-controlled function item modifying function, and a speech-controlled function item macro function.

Please refer to FIG. 2, which is a schematic diagram showing the hierarchical menu selection having a speech-controlled function according to a preferred embodiment of the present invention. Please also refer to FIG. 1. Under a speech-controlled function editing mode, the speech-controlled function item adding function records at least an option 76 sequentially selected from the hierarchical menu 7 by the user and adds a new speech-controlled function item 2 resulting from the selection to the speech-controlled function database 1. Take FIG. 2 for example, the speech-controlled function item adding function first activates a speech-controlled function editing mode (not shown) and sequentially selects “telephone directory” in the first-level menu 70, “Dial” in the second-level menu 71, “John” in the third-level menu 72 and “Cel 2” in the fourth-level menu 73. A new speech-controlled function item 2 generated from such a selection process allows the user to directly dial John's second cellular phone by means of the speech-controlled manner in the future. To easily memorize the new speech-controlled function item 2, the user can define a preferred command name 21 for the new speech-controlled function item 2. Meanwhile, the speech-controlled function editing module 3 automatically executes an execution path, which is the function shortcut 22 of the new speech-controlled function item 2 capable of directly dialing John's second cellular phone, sets the status indicator of the new speech-controlled function item 2 to be the operating state, and then adds the new speech-controlled function item 2 to the speech-controlled function database 1 for completing the speech-controlled function item adding function. In addition, the items in the first-level menu 70 in the aforementioned selection process can be replaced by the options on the desktop and the options on the status bar of the display.

The speech-controlled function item disabling function selects the available speech-controlled function item 2 in the speech-controlled function database 1 and sets the status indicator thereof to be the idle state, thereby enabling the selected speech-controlled function item 2 to enter the idle state.

The speech-controlled function item modifying function targets at modifying the command name 21 of the speech-controlled function item 2 in the speech-controlled function database 1, allowing the command to be more user-friendly and easily accessible and operable.

The speech-controlled function item macro function is illustrated as follows. It is assumed that the user intends to use a single speech command to sequentially execute several different application programs, such as using a speech command “Today's schedule” to sequentially execute 1. turn on “radio”; 2. tune to “TV news”; 3. open “calendar” and jump to today's schedule; and 4. open “e-mail”. To generate the macro, after the speech-controlled function item macro function (not shown) is performed in a speech-controlled function editing mode, the user can sequentially record the application programs including “radio”, “TV news”, “calendar” and “e-mail” as well as the relevant sub-menus (e.g. “radio channel”, “TV channel”, “today's schedule”, etc.) in a sequence as shown in the selection process in FIG. 2. The resulting macro resembles a new speech-controlled function item 2. In this example, the user may input “Tody's schedule” to the command name 21 of the speech-controlled function item 2; the speech-controlled function editing unit 3 automatically stores the sequential execution paths generated from the menu selection process of the application programs in the function shortcut 22 of the new speech-controlled function item 2, and sets the status indicator 23 of the new speech-controlled function item 2 to be the operating state. Likewise, a speech command “just relax” may be generated to carry out a macro containing 1. execute “MP3 playing software” and play a preset song “xxx”; and 2. execute a preset game program.

When a speech command is input to the electronic device 10 and the speech-controlled function executing mode is activated, the speech-controlled executing unit 4 converts the speech command into an electronic datum. The electronic datum is compared with the command name of the speech-controlled function item having the status indicator being the operating state to identify a matching speech-controlled function item. The matching speech-controlled function item is executed in accordance with the corresponding function shortcut, and the electronic datum is deleted right after the comparison with the speech command is finished.

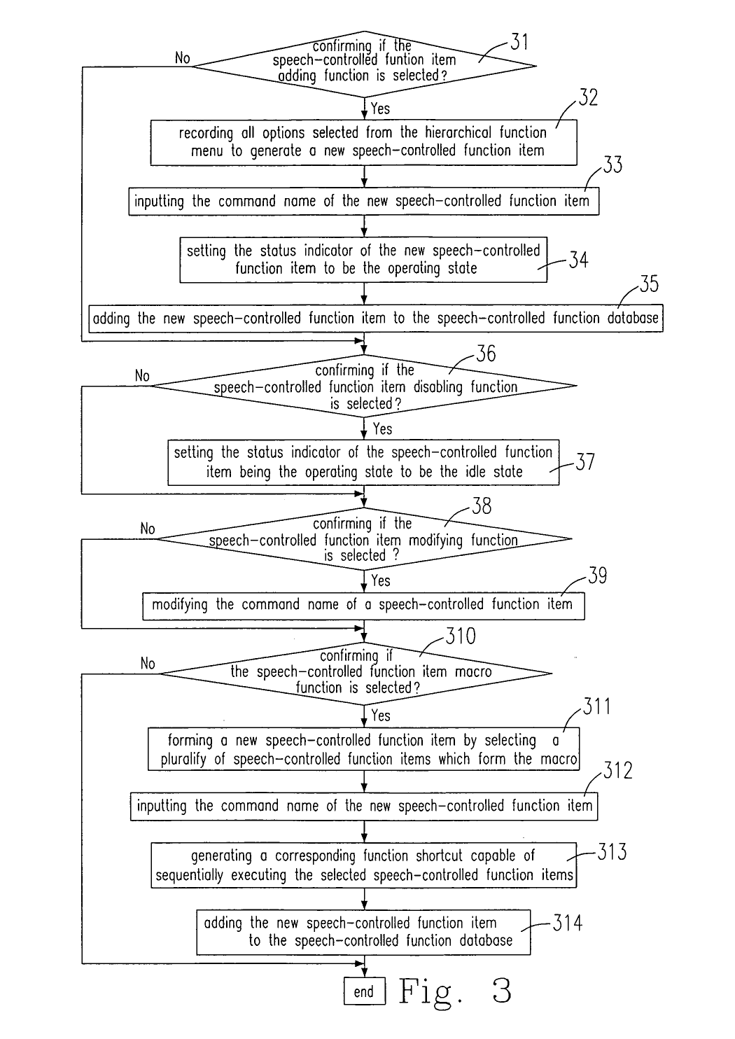

Please refer to FIG. 3, which is a flow chart of the user-defined speech-controlled function shortcut editing method according to a preferred embodiment of the present invention. The editing method includes steps of (1) confirming if the speech-controlled function adding function is selected (S31); (2) recording all options selected from the hierarchical menu to generate a new speech-controlled function item, if yes (S32); (3) inputting the command name of the new speech-controlled function item (S33); (4) setting the status indicator of the new speech-controlled function item to be the operating state (S34); (5) adding the new speech-controlled function item to the speech-controlled function database (S35); (6) confirming if the speech-controlled function item disabling function is selected (S36); (7) setting the status indicator of the speech-controlled function item having the status indicator being the operating state to be the idle state, if yes (S37); (8) confirming if the speech-controlled function item modifying function is selected (S38); (9) modifying the command name of a speech-controlled function item, if yes (S39); (10) confirming if the speech-controlled function item macro function is selected (S310); (11) forming a new speech-controlled function item by selecting a plurality of speech-controlled function items which form the macro, if yes (S311); (12) inputting the command name of the new speech-controlled function item (S312); (13) generating a corresponding function shortcut capable of sequentially executing the selected speech-controlled function item (S313); (14) adding the new speech-controlled function item to the speech-controlled function database (S314); (15) end.

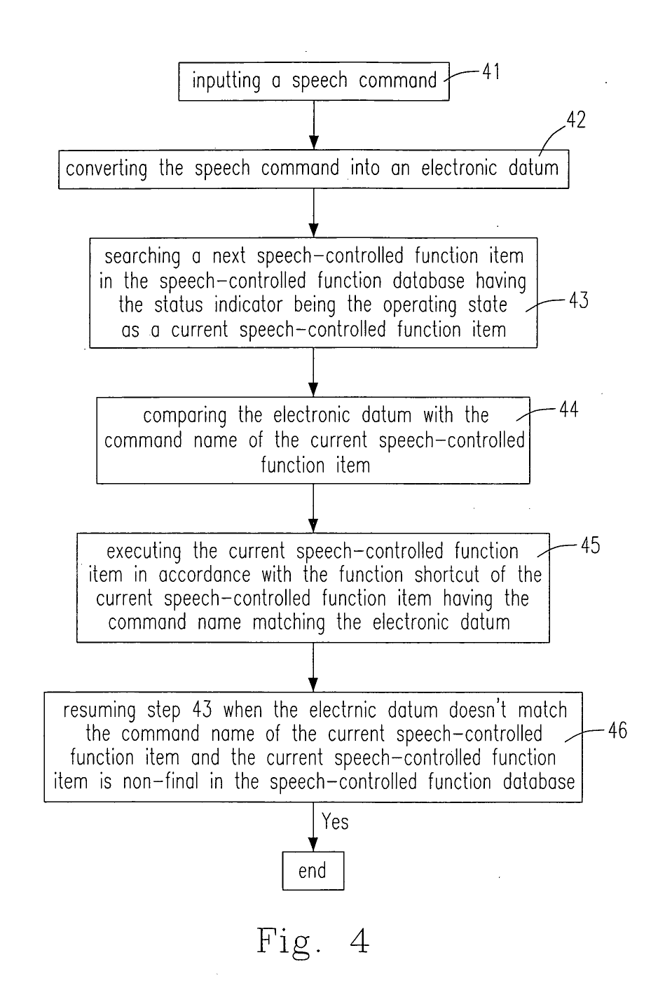

Please refer to FIG. 4, which is a flow chart of the user-defined speech-controlled function executing method according to a preferred embodiment of the present invention. The execution method includes steps of (1) inputting a speech command (S41); (2) converting the speech command into an electronic datum; (3) searching a next speech-controlled function item in the speech-controlled function database having the status indicator being the operating state as a current speech-controlled function item (S43); (4) comparing the electronic datum with the command name of the current speech-controlled function item (S44); (5) executing the current speech-controlled function item in accordance with the function shortcut of the current speech-controlled function item having the command name matching the electronic datum (S45); (6) resuming step 43 when the electronic datum doesn't match the command name of the current speech-controlled function item and the current speech-controlled function item is non-final in the speech-controlled function database (S46).

In sum, the present invention provides a design using the option of a hierarchical menu and an execution path defined by the user to execute the option in accordance with the execution path by means of the speech-controlled manner, and grouping a plurality of options as a macro to sequentially execute all options in the macro by means of the speech-controlled manner. In contrast to the prior art, the present invention provides a user-defined speech-controlled function path module and the method thereof to overcome the drawbacks of the prior art, making the present invention innovative, progressive and practical.

While the invention has been described in terms of what are presently considered to be the most practical and preferred embodiments, it is to be understood that the invention need not to be limited to the disclosed embodiment. On the contrary, it is intended to cover various modifications and similar arrangements included within the spirit and scope of the appended claims, which are to be accorded with the broadest interpretation so as to encompass all such modifications and similar structures.

What is claimed is:

1. A speech-controlled shortcut module for an electronic device to edit and execute at least a speech-controlled function item therein, comprising a speech-controlled database storing said at least a speech-controlled function item having:
a command name being a name of said at least a speech-controlled function item; and
a function shortcut storing an execution path of said at least a speech-controlled function item and formed by said electronic device to record at least an option of an hierarchical function menu sequentially selected by a user,
wherein when said user inputs a voice command, said electronic device recognizes said voice command and executes a corresponding speech-controlled function item.

2. The module of claim 1, wherein said at least a speech-controlled function item further comprises a status indicator being one of an operating state and an idle state.

3. The module of claim 1, wherein said electronic device comprises a microphone for said user to input said voice command.

4. The module of claim 2, further comprising a speech-controlled function editing unit to provide said user at least one selected from a group consisting of a speech-controlled function item adding function, a speech-controlled function item disabling function, a speech-controlled function item modifying function and a speech-controlled function item macro function.

5. The module of claim 4, wherein said speech-controlled function item adding function enables said electronic device to record a new speech-controlled function item resulting from said at least an option of said hierarchical function menu sequentially selected by said user under a speech-controlled function editing mode, to add said new speech-controlled function item to said speech-controlled function database, and to set said status indicator of said new speech-controlled function item to be said operating state, and said speech-controlled function item disabling function sets said status indicator of said speech-controlled function item to be said idle state.

6. The module of claim 4, wherein said speech-controlled function item modifying function enables to modify said command name of said at least a speech-controlled function item.

7. The module of claim 4, wherein said speech-controlled function item macro function enables to group a plurality of speech-controlled function items as a macro so as to be added to said speech-controlled function database as a new speech-controlled function item, a command name of said new speech-controlled function item is defined by said user, said plurality of speech-controlled items selected are sequentially executed in accordance with a function shortcut of said new speech-controlled function item, and a status indicator of said new speech-controlled function item is set to be said operating state.

8. The speech-controlled shortcut module of claim 1, further comprising a speech-controlled function executing unit, wherein an electronic data converted from a voice command is recognized while said user inputs said voice command and said speech-controlled function executing unit is activated, said electronic data is sequentially compared with said command name of said at least a speech-controlled function item having said status indicator being said operating state so as to identify a matching speech-controlled function, said matching speech-controlled function is executed in accordance with said function shortcut thereof, and said electronic data is deleted after compared with said voice command.

9. A speech-controlled shortcut editing method for an electronic device to edit a speech-controlled function database comprising plural speech-controlled function items and an operating speech-controlled function item, wherein each of said speech-controlled function items comprises a plurality of fields having at least a command name, a function shortcut and a status indicator under a speech-controlled function editing mode, comprising steps of:
(1) adding a new speech-controlled function item to said speech-controlled function database;
(2) disabling said operating speech-controlled function item;
(3) modifying at least a specific one of said plurality of fields; and
(4) adding a macro to execute a plurality of selected speech-controlled function items in accordance with a function shortcut to said speech-controlled function database.

10. The editing method of claim 9, wherein said step (1) comprises steps of:
recording at least an option selected from a hierarchical function menu to generate said new speech-controlled function item;
inputting a command name of said new speech-controlled function item; and
adding said new speech-controlled function item to said speech-controlled function database.

11. The speech-controlled shortcut editing method of claim 9, wherein said status indicator of said new speech-controlled function item is set to be an operating state in said step (1).

12. The speech-controlled shortcut editing method of claim 11, wherein said step (2) sets said status indicator of said operating speech-controlled function item from said operating state to an idle state.

13. The speech-controlled shortcut editing method of claim 9, wherein said specific one field in said step (3) is said command name.

14. The speech-controlled shortcut editing method of claim 9, wherein said step (4) at least comprises steps of:
forming a new speech-controlled function item by selecting said plurality of speech-controlled function items of said macro;
inputting a command name of said new speech-controlled function item;
generating a corresponding function shortcut of said new speech-controlled function item to execute said plurality of selected speech-controlled function items; and
adding said new speech-controlled function item to said speech-controlled function database.

15. A speech-controlled shortcut executing method for an electronic device to execute a speech-controlled function item in a speech-controlled function database comprising a plurality of speech-controlled function items, wherein each of said plurality of speech-controlled function items comprises a command name, a first function shortcut and a status indicator under a speech-controlled function editing mode, comprising steps of:
(1) inputting a voice command;
(2) recognizing said voice command and then converting it into an electronic datum;
(3) searching a next speech-controlled function item in said speech-controlled function database having said status indicator being an operating state as a current speech-controlled function item;
(4) comparing said electronic datum with said command name of said current speech-controlled function item;
(5) executing said current speech-controlled function item in accordance with said function shortcut of said current speech-controlled function item having said command name matching said electronic datum; and
(6) resuming said step (3) when said electronic datum doesn't match said command name of said current speech-controlled function item and said current speech-controlled function item is non-final in said speech-controlled function database.
